(19) United States
(12) Patent Application Publication
(10) Pub. No.: US 2013/0332834 A1
(43) Pub. Date: Dec. 12, 2013

(54) ANNOTATION AND/OR RECOMMENDATION OF VIDEO CONTENT METHOD AND APPARATUS

(71) Applicants: Wenlong Li, Beijing (CN); Yangzhou Du, Beijing (CN); Xiaofeng Tong, Beijing (CN); Yimin Zhang, Beijing (CN)

(72) Inventors: Wenlong Li, Beijing (CN); Yangzhou Du, Beijing (CN); Xiaofeng Tong, Beijing (CN); Yimin Zhang, Beijing (CN)

(21) Appl. No.: 13/995,484

(22) PCT Filed: Sep. 12, 2011
(86) PCT No.: PCT/CN11/01546

§ 371 Date: Aug. 23, 2013

(51) Int. Cl. G06F 3/0484

(52) U.S. Cl. CPC G06F 3/0484
USPC 715/719

(57) ABSTRACT

Methods, apparatuses and storage medium associated with cooperative annotation and/or recommendation by shared and personal devices. In various embodiments, at least one non-transitory computer-readable storage medium may include a number of instructions configured to enable a personal device (PD) of a user, in response to execution of the instructions by the personal device, to receive a user input selecting performance of a user function in association with a video stream being rendered on a shared video device (SVD) configured for use by multiple users, render an image frame of the video stream rendered on the shared video device at a time proximate to a time of the user input, and facilitate performance of the user function, which may include annotation of video objects. Other embodiments, including recommendation of video content, may be disclosed or claimed.

### RELATED APPLICATION

This application is related to:

(1) Personalized Video Content Consumption Using Shared Video Device and Personal Device, attorney docket 110466-182902, and

(2) Cooperative Provision of Personalized User Functions Using Shared and Personal Devices, attorney docket 110466-182901.

Both contemporaneously filed with the present application.

### TECHNICAL FIELD

This application relates to the technical fields of data processing, more specifically to methods and apparatuses associated with annotating and/or recommending video content, using shared and personal devices.

### BACKGROUND

The background description provided herein is for the purpose of generally presenting the context of the disclosure. Unless otherwise indicated herein, the materials described in this section are not prior art to the claims in this application and are not admitted to be prior art by inclusion in this section.

With advances in integrated circuit, computing, networking and other technologies, personal devices configured for use by a user, such as smartphones, tablet computers, and so forth, are increasingly popular. Concurrently, shared video devices configured for use by multiple users, such as televisions, or set-top boxes coupled to television remain popular, in part, because of their increased functionalities, such as high-definition video, surround sound, and so forth. Currently, except perhaps for the use of a personal device as a conventional remote control to a shared video device, there is little integration or cooperation between personal and shared video devices.

### BRIEF DESCRIPTION OF THE DRAWINGS

Embodiments of the present invention will be described by way of exemplary embodiments, but not limitations, illustrated in the accompanying drawings in which like references denote similar elements, and in which:

FIG. 1 is a block diagram illustrating an example shared and personal devices usage arrangement;

FIG. 2 illustrates one example each of a shared video device and a personal device in further detail;

FIG. 3 illustrates an example method of cooperative user function provision by shared and personal devices;

FIG. 4 illustrates various examples of methods of registration and/or association between the shared and personal devices;

FIG. 5 illustrates a user view of example cooperative personalized user function provision by shared and personal devices;

FIG. 6 illustrates another user view of selected ones of the cooperative personalized user functions provided by shared and personal devices;

FIG. 7 illustrates an example method of cooperative personalized recommendation by shared and personal devices;

FIG. 8 illustrates an example non-transitory computer-readable storage medium having instructions configured to practice all or selected aspects of the methods of FIGS. 3-4; and

FIG. 9 illustrates an example computing environment suitable for use as a shared or personal device; all arranged in accordance with embodiments of the present disclosure.

### DETAILED DESCRIPTION OF ILLUSTRATIVE EMBODIMENTS

Methods, apparatuses and storage medium associated with cooperative annotation and recommendation by shared and personal devices are disclosed herein. In various embodiments, a non-transitory computer-readable storage medium having a number of instructions configured to enable a personal device (PD) of a user, in response to execution of the instructions by the personal device, to receive a user input selecting performance of a user function in association with a video stream being rendered on a shared video device configured for use by multiple users, and render an image frame of the video stream rendered on the shared video device at a time proximate to a time of the user input. Further, the instructions, on execution, may further enable the personal device to facilitate performance of the user function. The user function in association with a video stream being rendered on a shared video device may include, but are not limited to, annotating an image frame of the video stream, or an object within the image frame, uploading the image frame to a social network or a cloud computing server, submitting a search based at least in part on the image frame or an object within, or conducting an e-commerce transaction with an e-commerce site resulted at least in part because of the image frame.

In various embodiments, the personal device may be any device configured for use by a user, e.g., a smartphone or a tablet computer. The shared video device may include any video device configured for use by multiple users, e.g., a television or a set-top box coupled to the television. The video stream may be a video stream being rendered in a picture-in-picture of the television.

In various embodiments, the instructions, on execution, may further enable the personal device, to request from the shared video device, in response to the user input, the image frame; and receive from the shared video device, subsequent to the request, the image frame. Further, the instructions, on execution, may further enable the personal device, to facilitate entry of an annotation to be associated with the video stream, the image frame, or an object within the image frame. In particular, the instructions, on execution, may further enable the personal device, to facilitate entry of an annotation to be associated with an object within the image frame, including facilitate selection of the object. The instructions, on execution, may further enable the personal device, to facilitate recognition of a user gesture made relative to the rendered image frame to select the object.

Additionally, the instructions, on execution, may further enable the personal device, to facilitate entry of textual annotations, or facilitate entry of a like or dislike recommendation. The instructions, on execution, may further enable the personal device, to recognize a thumb-up or a thumb-down user gesture to respectively facilitate entry of a like or dislike recommendation. The instructions, on execution, may further enable the personal device, to store entered annotation or submit entered annotation to the shared video device or a cloud computing server. The instructions, on execution, may further enable the personal device, to retrieve previously entered annotations, and facilitate edit of retrieved annotations.

Further, the instructions, on execution, may further enable the personal device, to analyze user inputs or annotations entered over a period of time, and make recommendations for video streams to be rendered on the shared video device, based at least in part on a result of the analysis.

In various embodiments, a personal apparatus may include one or more processors, and an input mechanism coupled with the one or more processors, and configured to receive a user input to select performance of a user function in association with a video stream being rendered on a shared video device configured for use by multiple users. The personal apparatus is configured for use by a user. Further, the personal apparatus may include a video/image component coupled with the one or more processors, and configured to render an image frame of the video stream rendered on the shared video device at a time proximate to a time of the user input, and a shared video device cooperation function operated by the one or more processors, coupled to the input mechanism and the video/image component, and configured to facilitate performance of the user function. Additionally, the shared video device cooperation function may be effectuated by the instructions of the earlier described computer-readable storage medium.

Further, a personal device (PD) method may include all or selected ones of the operations performed by the instructions of the earlier described computer-readable storage medium, when executed.

Various aspects of the illustrative embodiments will be described using terms commonly employed by those skilled in the art to convey the substance of their work to others skilled in the art. However, it will be apparent to those skilled in the art that alternate embodiments may be practiced with only some of the described aspects. For purposes of explanation, specific numbers, materials, and configurations are set forth in order to provide a thorough understanding of the illustrative embodiments. However, it will be apparent to one skilled in the art that alternate embodiments may be practiced without the specific details. In other instances, well-known features are omitted or simplified in order not to obscure the illustrative embodiments.

Further, various operations will be described as multiple discrete operations, in turn, in a manner that is most helpful in understanding the illustrative embodiments; however, the order of description should not be construed as to imply that these operations are necessarily order dependent. In particular, these operations need not be performed in the order of presentation.

The term “smartphone” as used herein, including the claims, refers to a “mobile phone” with rich functionalities beyond mobile telephony, such as, personal digital assistant (PDA), media player, cameras, touch screen, web browsers, Global Positioning System (GPS) navigation, WiFi, mobile broadband, and so forth. The term “mobile phone” or variants thereof, including the claims, refers to mobile electronic device used to make mobile telephone calls across a wide geographic area, served by many public cells.

The phrase “in one embodiment” or “in an embodiment” is used repeatedly. The phrase generally does not refer to the same embodiment; however, it may. The terms “comprising,” “having,” and “including” are synonymous, unless the context dictates otherwise. The phrase “A/B” means “A or B”. The phrase “A and/or B” means “(A), (B), or (A and B)”. The phrase “at least one of A, B and C” means “(A), (B), (C), (A and B), (A and C), (B and C) or (A, B and C)”. The phrase “a selected one of A or B,” as used herein refers to “A” or “B,” and does not in any way imply or require a “selection” operation to be performed.

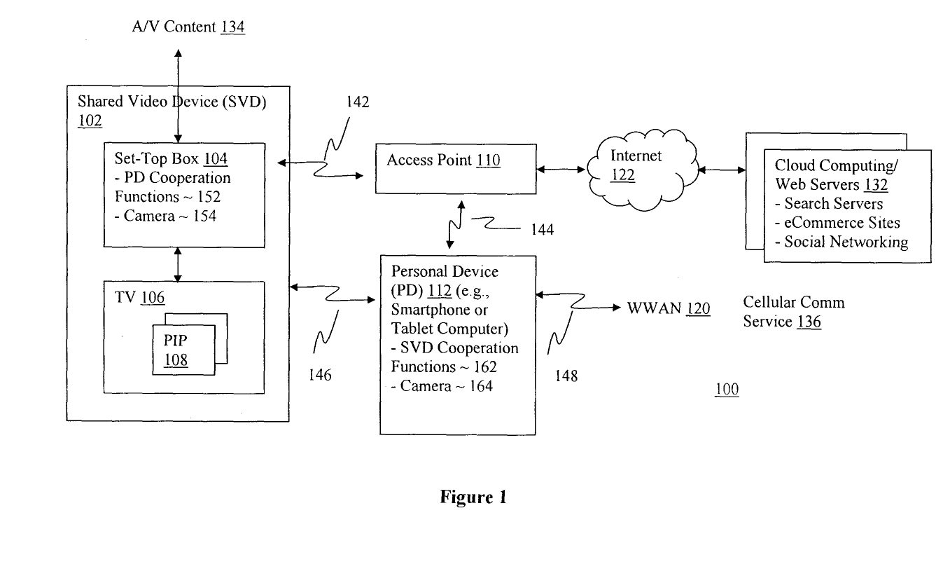

Referring now to FIG. 1, wherein a block diagram illustrating an example shared and personal devices usage arrangement, in accordance with various embodiments. As illustrated, arrangement 100 may include shared video device (SVD) 102 configured to receive and render audio/visual (A/V) content 134 for use by multiple users, and personal device (PD) 112 configured to provide various personal functions, such as mobile telephony, for use by a user. Further, SVD 102 and PD 112 may be respectively configured with PD cooperation functions 152 and SVD cooperation functions 162, to enable PD 112 to be employed to annotate video objects associated with video streams rendered on SVD 102, and/or making video content recommendation for consumption on SVD 102. Except for PD and SVD cooperation functions 152 and 162 provided in accordance with embodiments of the present disclosure, examples of SVD 102 may include a multiple device coupled combination of television 106 and set-top box 104, or a single device integrated combination of television 106 and set-top box 104, whereas, examples of PD 112 may include a smartphone or a tablet computer. In various embodiments, television 106 may include a picture-in-picture (PIP) feature with one or more PIP 108, and set-top box 104 may include a digital image capture device 154, such as a camera. Likewise, PD 112 may also include a digital image capture device 164, such as a camera.

As illustrated, SVD 102 may be configured to be coupled to, and selectively receive A/V content 134 from one or more A/V content sources (not shown), whereas PD 112 may be configured to be wirelessly 148 coupled to cellular communication service 136, via wireless wide area network (WWAN) 120. Examples of A/V content sources may include, but are not limited to, television programming broadcasters, cable operators, satellite television programming providers, digital video recorders (DVR), compact disc (CD) or digital video disc (DVD) players, or video cassette recorders (VCRs). Cellular communication service 136 may be Code Division Multiple Access (CDMA) service, Enhanced GPRS (EDGE) service, 3G or 4G service (GPRS=General Packet Radio Service).

Still referring to FIG. 1, in various embodiments, SVD 102 and PD 112 may be wirelessly 142 and 144 coupled with each other, via access point 110. In turn, access point 110 may further couple SVD 102 and PD 112 to remote cloud computing/web servers 132, via one or more private or public networks, including e.g., the Internet 122. In other words, SVD 102, PD 112 and access point 110 may form a local area network, such as a home network. Remote cloud computing/web servers 132 may include search services, such as Google® or Bing®, eCommerce sites, such as Amazon, or social networking sites, such as Facebook® or MySpace®. Further, in various embodiments, SVD 102 and PD 112 may be respectively configured to enable the devices to be wirelessly 146 coupled using personal and/or near field communication protocols. In various embodiments, wireless couplings 142 and 144 may include WiFi connections, whereas wireless coupling 146 may include a Bluetooth connection.

In various embodiments, SVD 102 and PD 112 may have respectively associated identifiers. For the embodiments, where SVD 102 includes television 106 with PIP 108, SVD 102 may further include logical identifiers respectively identifying the main picture and the PIP 108. Additionally, in various embodiments, the identifiers may be respectively included in at least discovery communications transmitted by SVD 102 and PD 112, to enable receivers of the communications, such as PD 112 and SVD 102, to be able to discern the senders of the communications.

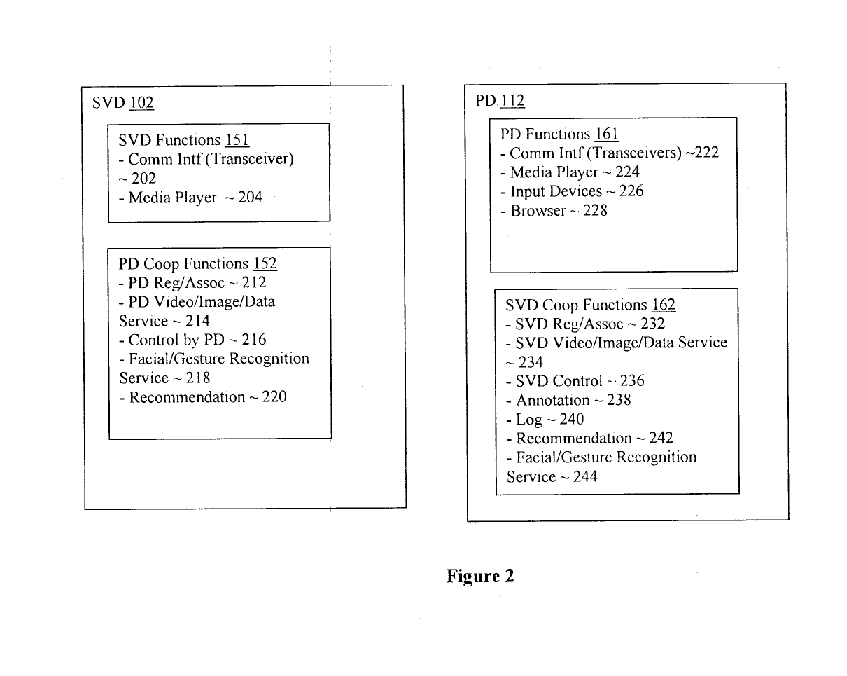

FIG. 2 illustrates one example each of SVD 102 and PD 112 in further detail, in accordance with various embodiments. As shown and described earlier, SVD 102 may include SVD functions 151 and PD cooperation functions 152, whereas PD 112 may include PD functions 161 and SVD cooperation functions 162.

In various embodiments, SVD functions 151 may include one or more communication interfaces 202, having respective transceivers, and media player 204, having one or more A/V decoders. Communication interfaces 202, having respective transceivers, may include a communication interface configured to receive A/V content from a television programming broadcaster, a cable operator, or a satellite programming provider, a communication interface configured to receive A/V content from a DVR, CD/DVD player or a VCR, a communication interface configured to communicate with access point 110, and/or a communication interface configured to directly communicate with PD 112. Media player 204, having one or more A/V decoders, may be configured to decode and render various A/V content streams. The various A/V decoders may be configured to decode A/V content streams of various formats and/or encoding schemes.

In various embodiments, PD cooperation functions 152 may include a PD registration/association function 212, a PD video/image/data service 214 and a control by PD function 216. Further, PD cooperation functions 152 may include facial/gesture recognition function 218 and recommendation function 220.

PD registration/association function 212 may be configured to register SVD 102 with a PD 112 or associate PD 112 with SVD 102. In various embodiments, registration/association function 212 may be configured to register/associate SVD 102 with a PD 112 by exchanging messages with identification and/or configurations. In alternate embodiments, registration/association function 212 may be configured to register/associate SD 102 with a PD 112, in cooperation with facial/gesture recognition service 218, using a facial recognition service. In various embodiments, registration/association function 212 may be configured to maintain a map of the PD 112 with whom SVD 102 is registered and/or associated. For various set-top box 104 and television 106 embodiments, where television 106 includes a PIP feature with one or more PIP 108, PD registration/association function 212 may be configured to register SVD 102 with a PD 112 or associate SVD 102 with a PD 112, at a PIP granularity level, to enable video streams rendered in the main picture and the PIP 108 to be logically associated with different PD 112. Further, PD registration/association function 212 may be configured to maintain the earlier described SVD 102 to PD 112 map at a PIP granularity level. In various embodiments, PD registration/association function 212 may be further configured to maintain the map to include a current status of the user of the PD 112, e.g., whether the user is among the current users of SVD 102. PD registration/association function 212 may be configured to update the status as the user becomes a current user of SVD 102 (or one of the current users of SVD 102), or ceases to be a current user of SVD 102.

PD video/image/data service 214 may be configured to provide video, images, and/or data to PD 112. In particular, PD video/image/data service 214 may be configured to capture an image or a video clip from a video stream being rendered on SVD 102 or to capture an image from a camera of SVD 102. The captured image or video clip may be stored and/or provided to PD 112. Further, PD video/image/data service 214 may be configured to provide the captured image or video clip from a video stream to a cloud computing server to identify the video stream, and/or to obtain metadata associated with the video stream. The metadata may be provided by the video stream creator/owner, distributor or associated advertisers. The metadata associated with the video stream may also be stored or provided to PD 112. Further, the viewing history may be stored on SVD 102.

PD video/image/data service 214 may also be configured to accept from PD 112, video, images, and/or data. For example, PD video/image/data service 214 may be configured to accept annotations entered by a user of PD 112 for images provided by SVD 102. PD video/image/data service 214 may also be configured to accept e-commerce transaction related information from PD 112, e.g., for virtual dressing using SVD 102 to facilitate a potential e-commerce transaction involving clothing. Likewise, the received video, images, and/or data from PD 112 may be stored on SVD 102.

Control by PD function 216 may be configured to accept controls from PD 112, and in response, control SVD 102 accordingly, including, but is not limited to, controlling capturing of an image from a video stream being rendered on SVD 102, or controlling rendering of a video stream on SVD 102, such as stopping, pausing, forwarding or rewinding the video stream. Control by PD function 216 may also be configured to accept controls from PD 112, to adjust the rendering of a 3DTV video stream, to control its quality.

Facial/Gesture Recognition service 218 may be configured to provide a number of facial recognition and/or gesture recognition services. Facial recognition services may include recognition of faces in a picture, including age, gender, ethnicity, and so forth. Facial recognition services may further include recognition of facial expressions, e.g., approved, disapproved, interested, disinterested, happy, sad, angry or at peace. Facial recognition may be based on one or more facial or biometric features. Gesture recognition services may include recognition of a number of hand gestures, including but are not limited to, a thumb up hand gesture denoting “like,” a thumb down hand gesture denoting “dislike,” two fingers moving away from each other denoting “enlarge,” two fingers moving towards each other denoting “shrink,” two fingers or two hands crossing each other denoting “swap.”

Recommendation function 220 may be configured to, individually or in combination with recommendation function 242, provide a user of PD 112 with personalized recommendations based on interactions/cooperation with PD 112, using SVD 102, and/or between SVD cooperation functions 162 and PD functions 161. Personalized recommendations may be other contents, other web sites, other advertisements, other goods, etc. of potential interest to the user of PD 112.

In various embodiments, PD registration/association function 212 may be configured to cooperate with facial/gesture recognition function 218 to effectuate registration of SVD 102 or logical units of SVD 102 (e.g., PIP 108, if SVD 102 includes television 106 with PIP 108) with various PD 112, or association of various PD 112.

The term “association” as used herein refers to a relationship between two entities, e.g., SVD 102 and PD 112, whereas the term “registration” as used herein refers to an action of one entity with another entity, e.g., an “action” for the purpose of forming an “association” between the entities. In other words, the present disclosure anticipates an “association” between SVD 102 and PD 112 may be formed unilaterally or bilaterally. For example, SVD 102, by virtue of its knowledge of a particular PD 112, such as its identification, may unilaterally consider the particular PD 112 be associated with the SVD 102, without itself registering with the particular PD 112 or requiring the particular PD 112 to register with itself. On the other hand, SVD 102 and/or PD 112 may explicitly identify themselves to each other (“register”) to form the association.

Continue to refer to FIG. 2, in various embodiments, PD functions 161 may include one or more communication interfaces 222, having respective transceivers, media player 224, having one or more A/V decoders, input devices 226, and browser 228. Communication interfaces 222 may include a communication interface configured to communicate with a cellular communication service, a communication interface configured to communicate with access point 110, and/or a communication interface configured to directly communicate with SVD 102. Media player 224, having one or more A/V decoders, may be configured to decode and render various A/V content streams. The various A/V decoders may be configured to decode A/V content streams of various formats and/or encoding schemes.

Input devices 226 may be configured to enable a user of PD 112 to provide various user inputs. Input devices 226 may include a keyboard (real or virtual) to enable a user to provide textual input, and/or a cursor control device, such as a touch pad, a track ball, and so forth. In various embodiments, input devices 226 include video and/or touch sensitive screen to enable a user to provide a gesture input. Gesture inputs may include the same or different hand gesture described earlier with respect to facial/gesture recognition service 218.

Browser 228 may be configured to enable a user of PD 112 to access a remote search service, an e-commerce site or a social network on the Internet. Examples of a search service may include Google®, Bing® and so forth. An e-commerce site may include Amazon, Best Buy and so forth. Social network may include Facebook®, MySpace®, and so forth. Browser 228 may also be configured to enable the user of PD 112 to participate in a Special Interest Group (SIG) associated with the program of a video stream being rendered on SVD 102. Such SIG may be pre-formed or dynamically formed based on current content being delivered by a content provider. Such SIG may also be geographically divided, or by PD device types.

In various embodiments, SVD cooperation functions 162 may include a SVD registration function 232, a SVD video/data service 234, a SVD control function 236, an annotation function 238, and a log function 240. SVD cooperation functions 162 may further include recommendation function 242, and facial/gesture recognition service 244.

SVD registration/association function 232, similar to PD registration/association function 212 of SVD 102, may be configured to register PD 112 with a SVD 102, or associate SVD 102 with PD 112. For various set-top box 104 and television 106 embodiments, where television 106 includes a PIP feature, SVD registration function 232 may be configured to register PD 112 with a SVD 102, or associate SVD 102 with PD 112, at a PIP granularity level, to enable video streams rendered in the main picture and the PIP 108 to be independently associated with the same or different PD 112.

SVD video/image/data service 234, similar to PD video/image/data service 214 of SVD 102, may be configured to provide to or accept from SVD 102, video, image and/or data, including in particular, a video segment derived from a video stream being rendered on SVD 102, a picture frame captured from the video stream or by a camera of SVD 102, or a picture captured by a camera of PD 112. SVD video/image/data service 234 may also be configured to send and/or accept video, image and/or data to/from a cloud computing server. SVD video/image/data service 234 may be configured to cooperate with browser 228 to effectuate the send and accept of video, image and/or data to/from a cloud computing server.

SVD Control 236 may be configured to provide controls to SVD 102 to control SVD 102. As described earlier, with respect to Control by PD 216 of SVD 102, controls may include, but are not limited to, enlarging or shrinking a PIP 108, swapping video streams between the main picture and a PIP 108, stop, pause, fast forward or rewind a video stream. SVD Control 236 may also be configured to provide controls to SVD 102 to adjust the rendering of a 3DTV video stream on to control SVD 102, to control its quality. Further, SVD Control 236 may be configured to provide automatic video stream switching during commercials, and automatic switch backs, when the commercials are over.

Annotation function 238 may be configured to enable a user of PD 112 to annotate objects, such as images or objects with the images, obtained from SVD 102. Annotation function 238 may be configured to facilitate annotation be entered textually through e.g., a keyboard device or a cut and paste function. Annotation function 238 may be configured to facilitate annotation be entered via hand gestures, e.g. hand gestures denoting “like” or “dislike”.

Log function 240 may be configured to log the interactions or cooperation between SVD 102 and PD 112, and/or between PD functions 161 and SVD cooperation functions 162, including e.g., annotations entered for various objects. Log function 240 may be configured to store the interaction and/or cooperation histories, including e.g., annotations entered for objects, be stored locally in PD 112, on SVD 102 or with a cloud computing server. Log function 240 may be configured to cooperate with SVD video/image/data service 234 to effectuate storing interaction and/or cooperation histories with SVD 102 or a cloud computing server.

Recommendation function 242, similar to recommendation function 220 of SVD 102, may be configured to, individually or in combination with recommendation function 220, provide a user of PD 112 with personalized recommendations based on the logged interactions/cooperation with SVD 102, using PD 112, and/or between PD functions 161 and SVD cooperation functions 162. Recommendation function 242 may be further configured to employ other data available on PD 112, for example, trace data, such as location visited, recorded by a GPS on PD 112.

Before continuing with further description, it should be noted while embodiments of SVD 102 and PD 112 were illustrated in FIG. 2, with both devices respectively having recommendation functions 220 and 242, and facial/gesture recognition services 218 and 244, other embodiments may be practiced with only one or none of SVD 102 and PD 112 having a recommendation function or facial/gesture recognition service. Similarly, while for ease of understanding, video/image/data services 214 and 234, and facial/gesture recognition services 218 and 244 have been described as combined services, in alternate embodiments, the present disclosure may be practiced with one or both of these services sub-divided into separate services, e.g., video/image/data service sub-divided into separate video, image and data services, or facial/gesture recognition service sub-divided into separate facial, and gesture recognition services.

Accordingly, on registration or association, PD cooperation function 152 and SVD cooperation function 162 may cooperate to provide various personalized user functions to a user of PD 112. For example, video/image/data services 214 and 234 may cooperate to enable an image frame from a video stream being rendered on SVD 102 (e.g., in a main picture or a PIP 108 of a television) to be provided from SVD 102 to PD 112. The image frame may be provided in response to a request by a user of PD 112 for cooperative user functions. The image frame may be an image frame rendered on SVD 102 at substantially the time the request was made at PD 112. The time of request may be conveyed to service 214 by service 234.

On receipt of the image frame, a user of PD 112 may use annotation function 238 to annotate the image frame. Annotation function 238 may by itself, or in cooperation with facial/gesture recognition service 244, to enable a user of PD 112 to identify an object, such as a person or an item, within the image frame, and annotate the object specifically (as opposed to the whole image). Facial/gesture recognition service 244 may enable an object within the image frame be identified through recognition of a user gesture made relative to the image frame, e.g., circling an object, or pointing to an object. Log function 240 may enable the annotated image frame and/or object within the image frame to be stored on PD 112 or back on SVD 102, using video/image/data services 214 and 234. Alternatively, video/image/data services 214, by itself or in cooperation with browser 228, may also enable the annotated image frame or object within the image frame be uploaded to a social network or a cloud computing server.

As a further example, a user of PD 112 seeing a segment or a character of interest in a video stream being rendered on SVD 102 may request an image frame of the video stream. In response to the request, services 214 and 234 may cooperate to provide PD 112 with an image frame rendered substantially at the time the request was made. On receipt of the image frame, using annotation function 238, the user may annotate the image frame, an item or a character with the image frame, and thereafter store the annotated image frame or item/character within the image frame on PD 112, SVD 102, a social network or a cloud computing server 132. For annotating a character or an item within the image frame, a user, using recognition/gesture recognition service 244, may e.g., circle or point to the character or the item within the image frame with a user gesture.

As another example, video/image/data service 234 may also cooperate with browser 228 to enable a received image frame to be provided to a search service to perform a search, based at least in part on the received image frame. Similarly, video/image/data service 234 may also cooperate with browser 228 to enable a user of PD 112 to engage in an e-commerce transaction with an e-commerce site, where the e-commerce transaction is at least partially a result of the received image frame. More specifically, on seeing an item of interest in a video stream being rendered on SVD 102, a user of PD 112 may request an image frame, and cause an image frame having the item be provided to PD 112, using services 214 and 234, as described earlier. On receipt of the image frame, and after highlighted the item of interest, the user may further cause a search of the item be performed, using browser 228. On locating the item for sale on an e-commerce site, the user may engage the e-commerce site in an e-commerce transaction to purchase the item.

As still another example, control by PD function 216 and SVD control function 236 may cooperate to enable a user of PD 112 to control operations of SVD 102. More specifically, with facial/gesture recognition service recognizing a particular user gesture, control by PD function 216 and SVD control function 236 may cooperate to respond and enable a segment of a video stream being rendered on SVD 102 be re-played on PD 112. Further, in response to a recognition of another user gesture input, control by PD function 216 and SVD control function 236 may cooperate to enable a video stream being rendered on SVD 102 to stop, pause, fast forward or rewind. Similarly, in response to a recognition of still another gesture, control by PD function 216 and SVD control function 236 may cooperate to enable a PIP 108 of SVD 102 be enlarged or shrunk, or two video streams being rendered in a main picture and in a PIP 108 be swapped.

As still another example, log function 240 may be configured to log the interactions or co-operations between SVD 102 and PD 112, and/or between PD functions 161 and SVD cooperation functions 162, for a time period, on a user control/selectable basis. As described earlier, the logged information may be stored locally on PD 112, on SVD 102 or on a cloud computing server. Therefore, recommendation function(s) 220 and/or 242, individually or in combination, may be employed to analysis the logged interactions or cooperation, and make various recommendations, such as, other video content to be viewed on SVD 102, other web sites or content to be visited/browsed on PD 112, and/or other items to be purchased.

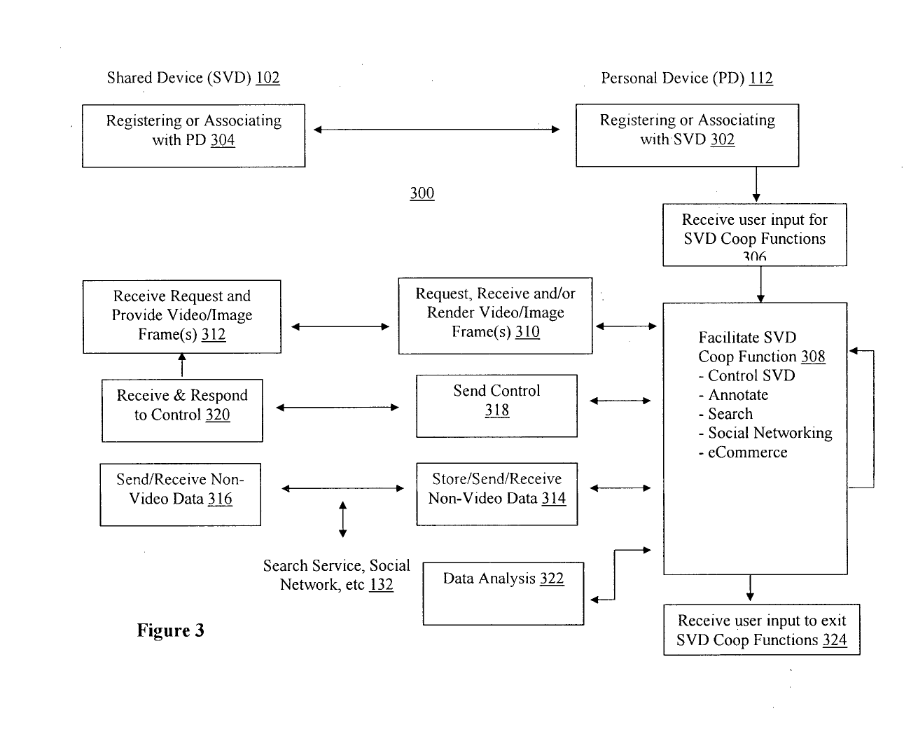

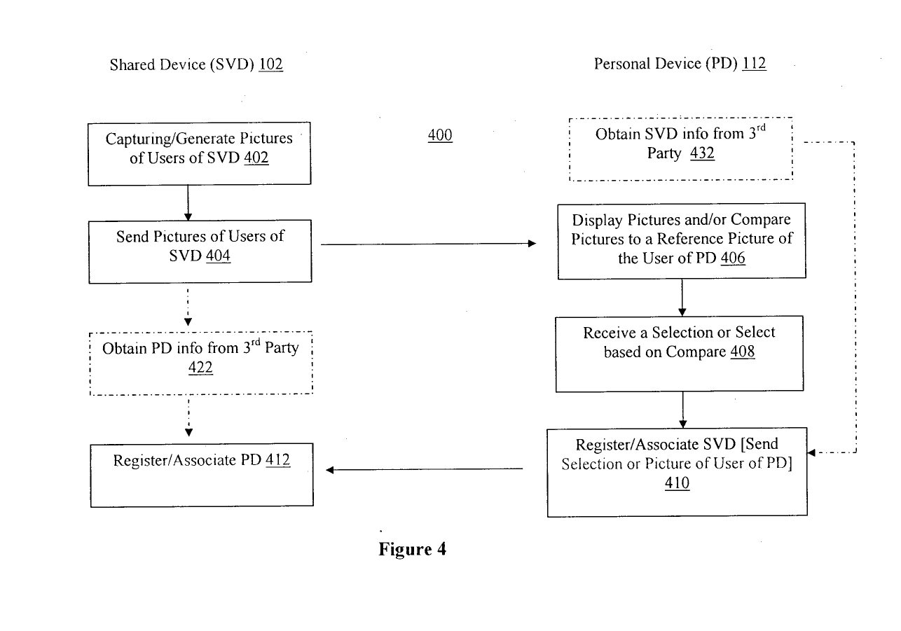

FIG. 3 illustrates an example method of cooperative personalized user function provision by shared and personal devices, in accordance with various embodiments. As illustrated, method 300 may begin at block 302 and/or 304 with SVD 102 and/or PD 112 register or associate with each other, to be described more fully below, with references to FIG. 4. In various embodiments, method 300 may be practiced with PD 112 registers itself with SVD 102 or otherwise associates SVD 102 to itself. In other embodiments, method 300 may be practiced with SVD 102 registers itself with PD 112 or otherwise associates PD 112 with itself. In still other embodiments, method 300 may be practiced with SVD 102 and PD 112 register or otherwise associate themselves with each other.

In various embodiments, SVD 102 and PD 112 may also exchange configuration information, as part of the registration process, to facilitate subsequent communications. For example, SVD 102 and PD 112 may exchange their respective capability information, such as, processing power, encoding/decoding schemes supported, messaging protocols supported, and so forth. In various embodiments, SVD 102 and/or PD 112 may also be configured, as part of the registration process, to cause required software and/or updates to be pushed to and/or installed on the other device.

On registration or association, method 300 may proceed to block 306 where PD 112 may receive an indication or a selection from a user of PD 112 to have SVD 102 and PD 112 cooperate to provide personalized user functions. From block 306, method 300 may proceed to block 308, where PD 112 may cooperate with SVD 102 to facilitate cooperative provision of personalized user functions to the user.

From block 308, method 300 may proceed to block 310, then to block 312, and then back to block 310, where an image frame of a video stream being rendered on SVD 102 may be requested, provided to, and rendered on PD 112. As described earlier, in various embodiments, the image frame may be an image frame rendered on SVD 102 at substantially the time the request was made on PD 112. From block 310, method 300 may proceed back to block 308, where a user may annotate the image frame or an object within the image frame.

Thereafter, from block 308, in response to another user input, method 300 may proceed to block 314, then to block 316, to store the annotated image or object within the image frame on PD 112 or SVD 102. From block 316, method 300 may return to block 308 via block 314. Alternatively, at block 308, with or without, as well as before or after annotating an image or an object within an image, method 300 may remain in block 308 to perform a search based at least in part on the image frame or an object therein, and/or to perform an e-commerce transaction with an e-commerce site resulted at least in part because of the image frame or an object within.

Thereafter, or in lieu of the earlier described operations, at block 308, a control of SVD 102 may be received. As described earlier, the control may be inputted via a gesture of the user of PD 112. The control, as described earlier, may include, but is not limited to, requesting a replay of a segment of a video stream being rendered on SVD 102 on PD 112, requesting SVD 102 to stop, pause, fast forward or rewind a video stream being rendered on SVD 102, requesting an enlargement or shrinking of a PIP 108, and/or requesting the main picture and a PIP 108 be swapped. On receipt of the control, method 300 may proceed from block 308 to block 318, then onto block 320 to cause the control be sent from PD 112 to SVD 102, and the control be processed and responded to on SVD 102. From block 320, if the control is to replay a video segment on PD 112, method 300 may return to block 308 via blocks 312 and 310, otherwise, method 300 may return to block 308, via block 318.

Thereafter, or in lieu of the earlier described operations, at block 308, method 300 may proceed to block 322, where analysis of the historical interactions/cooperation between SVD 102 and PD 112 may be performed, and personalized recommendations for other content consumption or user actions may be presented to the user of PD 112.

Thereafter, the above described operations may be repeated, in response to various further user inputs. Eventually, method 300 may proceed from block 308 to block 324, wherein a user input to exit the cooperative provision of user function may be received. On receipt of such input, method 300 may terminate.

FIG. 4 illustrates various examples of methods of registration and/or association between the shared and personal devices, in accordance with various embodiments. As illustrated, method 400 may begin e.g., at block 402, with SVD 102 (equipped with an image capturing device, such as, a camera) capturing pictures of its users. In various embodiments, SVD 102 may capture pictures of its users by capturing a picture of the space in front SVD 102, and then analyze the picture (using e.g., facial/gesture recognition service 218) for faces of users. On identifying new user faces, SVD 102 (using e.g. registration/association function 212) may generate pictures of the new users. SVD 102 may perform the capture and generate operations periodically, e.g., on power on, and therefore periodically on a time basis or on an event driven basis, e.g. on changing of the video stream being rendered or on changing of the genre of the video stream being rendered.

From block 402, method 400 may proceed to block 404, where SVD 102, in response to detection of PD 112 or contact by PD 112, may send pictures of users of SVD 102 to PD 112. From block 404, method 400 may proceed to block 406, where PD 112, for certain “manual” embodiments, may display the received pictures for a user of PD 112 to confirm whether one of the received pictures is a picture of the user of PD 112. Alternatively, PD 112, for certain “automated” embodiments, using e.g., facial/gesture recognition service 244, may compare the received pictures with a reference picture of the user of PD 112. The reference picture of the user of PD 112 may be previously provided to PD 112, or captured by PD 112 (for embodiments equipped with an image capture device, such as, a camera).

From block 406, method 400 may proceed to block 408, where PD 112, for the “manual” embodiments, may receive a selection of one of the received pictures from the user of PD 112, indicating the selected picture of the user of SVD 102 corresponds to the user of PD 112. For the “automated” embodiments, PD 112 may select one of the received pictures that substantially match the reference picture.

From block 408, method 400 may proceed to block 410, where PD 112 may associate itself with SVD 102. In associating itself with SVD 102, PD 112 may send the selection info (provided by the user or by the comparison operation) to SVD 102 to register itself with SVD 102 (or a logical unit of SVD 102, such as, a PIP 108 of a television 106 of SVD 102).

From block 410, method 400 may proceed to block 412, where SVD 102 may respond to the provided selection, and associate itself with PD 112, including, associating the user of the selected picture with PD 112. In various embodiments, where PD 112 also maintains a map of the various SVD 102 it is associated with (such as a SVD 102 at the primary residence, a SVD 102 at the beach house, and so forth), in response, SVD 102 may register itself with PD 112.

In alternate embodiments, from block 404, method 400 may proceed to block 422 instead, where at block 422, SVD 102 may contact an external source, e.g., a cloud computing server, to obtain identification and/or configuration information of PD 112, using the captured/generated pictures of its users. From block 422, method 400 may proceed to block 412, where SVD 102 may associate itself with all PD 112 it was able to obtain at least identification information, including, respectively associating the user pictures with the PD 112 it was able to obtain identification information based on the user pictures.

In alternate embodiments, method 400 may also begin at block 432 instead, with PD 112, contacting an external source, e.g., a cloud computing server, to obtain identification and/or configuration information of SVD 102. If successful, from block 432, PD 112 may proceed to block 410, where PD 112 associates SVD 102 to itself. At block 410, PD 112, may register itself with SVD 102. From block 410, method 400 may proceed to block 412, as described earlier.

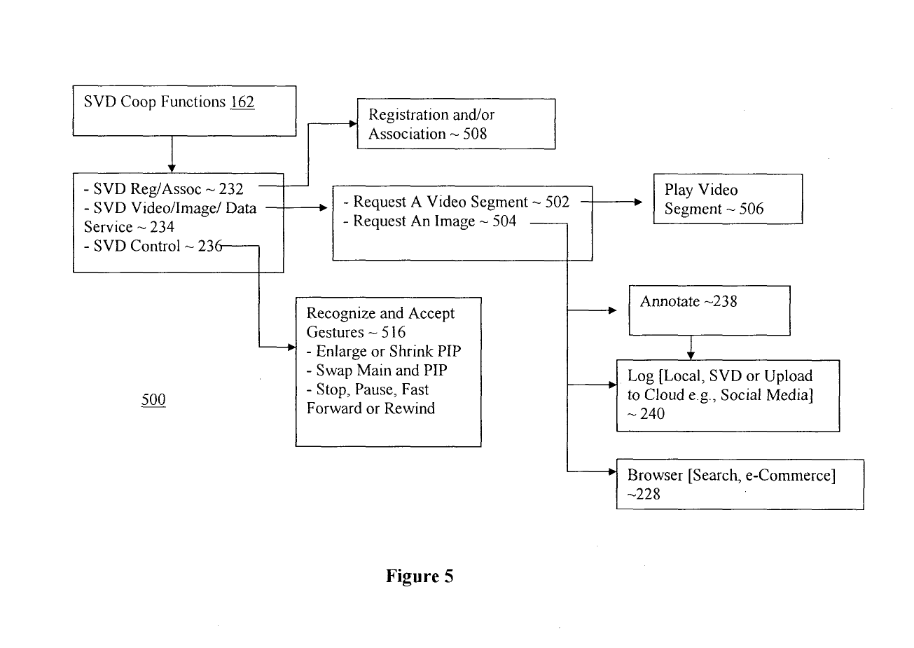

FIG. 5 illustrates a user view of cooperative personalized user function provision by shared and personal devices, in accordance with various embodiments of the present disclosure. As illustrated, initially, user of PD 112 may be presented with the option, via, e.g., an icon displayed on PD 112, to launch SVD cooperative function 162 (to facilitate user function in cooperation With SVD 102). In response to the selection of the option, the user of PD 112 may be presented with the options of selecting SVD registration/association function 232, SVD video/image/data service 234, or SVD control service 236.

On selection of SVD video/image/data service 234, the user of PD 112 may be presented with the options of requesting 502 a video segment of a video stream being rendered on SVD 102, or requesting 504 an image frame of a video stream being rendered on SVD 102. On selection of the option to request 502 a video segment of a video stream being rendered on SVD 102, and receive, in response, the video segment, PD 112 (using e.g. media player 224), after making the request, the user of PD 112 may be presented with the option of playing/rendering 506 the video segment.

On selection of the option to request 504 an image frame of a video stream being rendered on SVD 102, and receive, in response, the image frame, after making the request, the user of PD 112 may be presented with the options of using the annotation function 238 (to annotate the image or an object therein), the log function 240 (to store the image or an object therein, with or without an annotation), or browser 228 (to submit a search to an online search service, subsequently to conduct an e-commerce transaction with an e-commerce site, to participate in a SIG).

In response to the selection of SVD Control function 236, the user of PD 112 may be provided with the gesture recognition function 516 to receive and accept gestures to control SVD 102, e.g., to enlarge or shrink a PIP 108, to swap two video streams between the main picture and a PIP 108, or to stop, pause, fast forward or rewind a video stream being rendered on SVD 102.

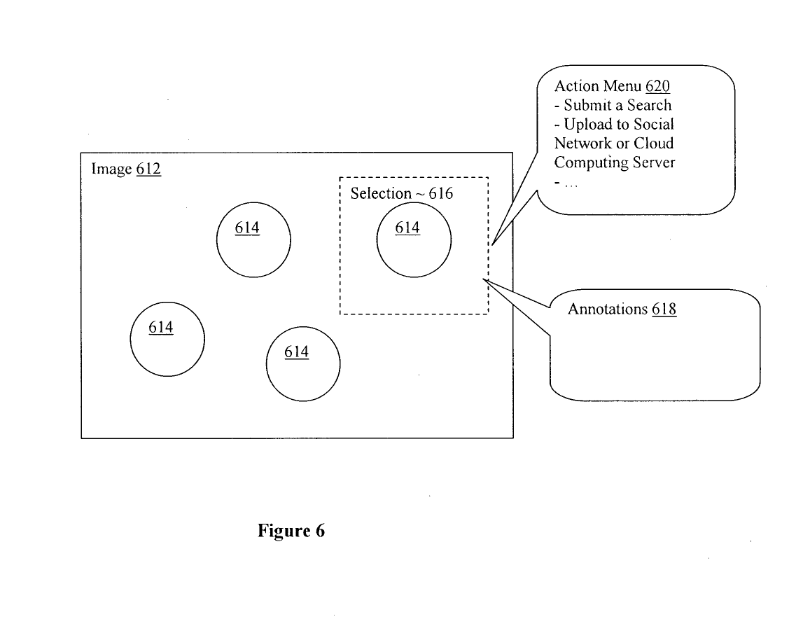

FIG. 6 illustrates another user view of selected cooperative personalized user function provision by shared and personal devices, in accordance with various embodiments of the present disclosure. Shown in FIG. 6 is an image 612 displayed on PD 112. Image 612 may be received from SVD 102. Further, image 612 may be provided by SVD 102 in response to a request of PD 112. As illustrated, image 612 may include a number of objects 614, such as person, items, building, landmarks, vegetations and so forth. One or more of the objects 614 may be selected, as depicted by the dotted line encircling rectangle 616. As described earlier, the selection may be made through hand gestures of the user.

As illustrated, on selection of one or more objects, and in response to a request of the user, a pop-up area 618 may be provided for the user to enter annotations and display the annotations entered. As described earlier, the annotations may be entered textually using e.g., a keyboard, a cut and paste function, and so forth. Further, alternatively, annotations may be entered through recognition of hand gestures, such as thumb up to denote “like,” or thumb down to denote “dislike,” and so forth.

With or without annotations, in response to a user request, a pop-up menu 620 may be presented providing the user of PD 112 with the choices of a list of functions, e.g., submit a search based on the image or selected object, upload the image or the selected object to a social network or a cloud computing server, or conduct a e-commerce transaction with a e-commerce site.

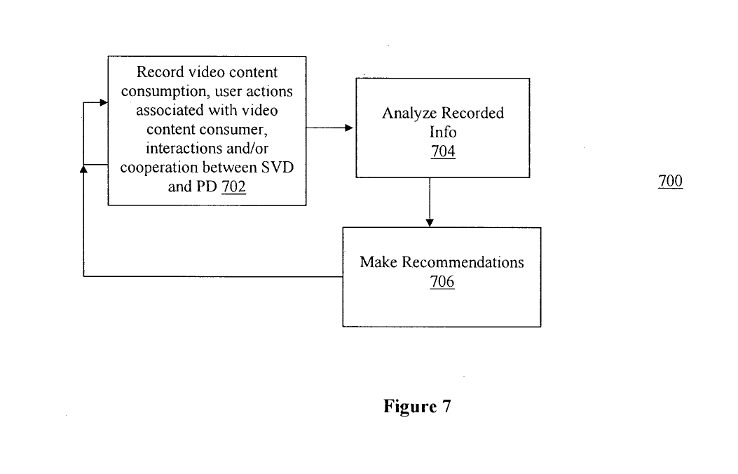

FIG. 7 illustrates an example of cooperative personalized recommendation by shared and personal devices, in accordance with various embodiments of the present disclosure. As illustrated, method 700 may start at block 702 with PD 112, by itself or in cooperation with SVD 102, logging the interactions and cooperation between PD 112 and SVD 102. As described earlier, the logged information may be stored locally on PD 112, on SVD 102, or on a cloud computing server. The operations of block 702 may be continuous.

From block 702, periodically, method 700 may proceed to block 704, where SVD 102 and/or PD 112, individually or in combination, may analyze the logged/stored interaction or cooperation information. From block 704, method 700 may proceed to block 706, wherein SVD 102 or PD 112 may make personalized recommendations to the user of PD 112, based at least in part on the result of the analysis. As described earlier, the personalized recommendations may include personalized recommendation of a video stream, a web site, and so forth.

From block 706, method 700 may return to block 702, and proceed there from as described earlier.

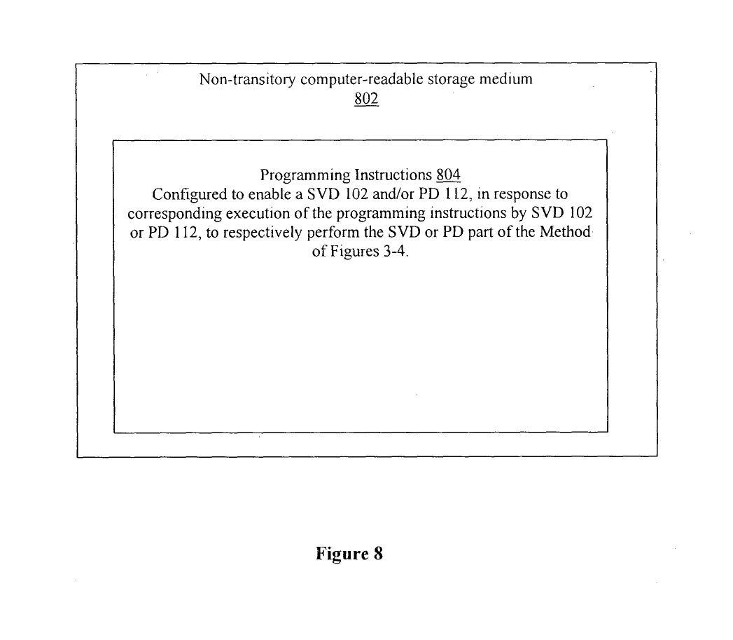

FIG. 8 illustrates a non-transitory computer-readable storage medium, in accordance with various embodiments of the present disclosure. As illustrated, non-transitory computer-readable storage medium 802 may include a number of programming instructions 804. Programming instructions 804 may be configured to enable a SVD 102 or a PD 112, in response to corresponding execution of the programming instructions by SVD 102 or PD 112, to perform operations of the SVD or PD portion of methods 300-400 earlier described with references to FIGS. 3 and 4. In alternate embodiments, programming instructions 804 may be disposed on multiple non-transitory computer-readable storage media 802 instead.

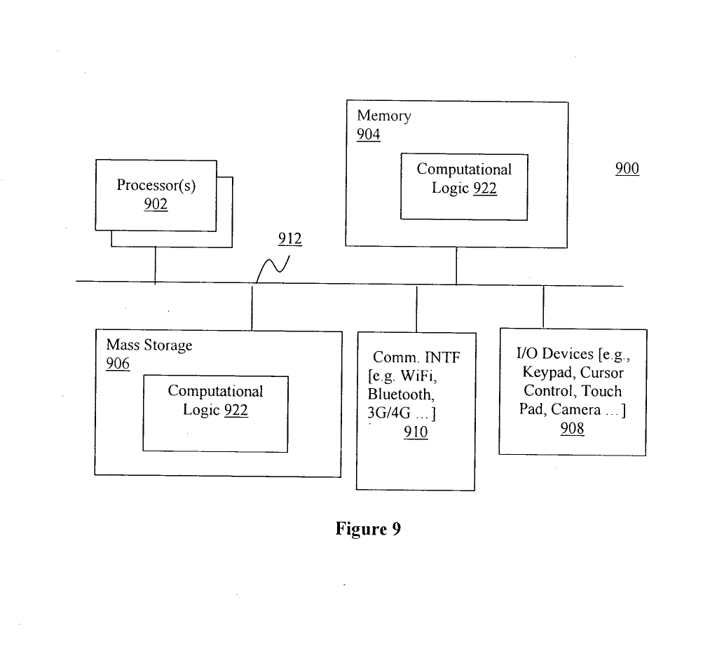

FIG. 9 illustrates an example computer system suitable for use as a SVD or a PD in accordance with various embodiments of the present disclosure. As shown, computing system 900 includes a number of processors or processor cores 902, and system memory 904. For the purpose of this application, including the claims, the terms “processor” and “processor cores” may be considered synonymous, unless the context clearly requires otherwise. Additionally, computing system 900 includes mass storage devices 906 (such as diskette, hard drive, compact disc read only memory (CD-ROM) and so forth), input/output devices 908 (such as display, keyboard, cursor control, touch pad, camera, and so forth) and communication interfaces 910 (such as, WiFi, Bluetooth, 3G/4G network interface cards, moderns and so forth). The elements are coupled to each other via system bus 912, which represents one or more buses. In the case of multiple buses, they are bridged by one or more bus bridges (not shown).

Each of these elements performs its conventional functions known in the art. In particular, system memory 904 and mass storage 906 may be employed to store a working copy and a permanent copy of the programming instructions implementing the SVD or PD portion of methods 300-400 earlier described with references to FIGS. 3 and 4, that is PD cooperation function 152 or SVD cooperation function 162, or portions thereof, herein collectively denoted as, computational logic 922. Computational logic 922 may further include programming instructions to practice or support SVD functions 151 or PD functions 161, or portions thereof. The various components may be implemented by assembler instructions supported by processor(s) 902 or high-level languages, such as, for example, C, that can be compiled into such instructions.

The permanent copy of the programming instructions may be placed into mass storage 906 in the factory, or in the field, through, for example, a distribution medium (not shown), such as a compact disc (CD), or through communication interface 910 (from a distribution server (not shown)). That is, one or more distribution media having an implementation of computational logic 922 may be employed to distribute computational logic 922 to program various computing devices.

The constitution of these elements 902-912 are known, and accordingly will not be further described.

Although specific embodiments have been illustrated and described herein, it will be appreciated by those of ordinary skill in the art that a wide variety of alternate and/or equivalent implementations may be substituted for the specific embodiments shown and described, without departing from the scope of the embodiments of the present disclosure. This application is intended to cover any adaptations or variations of the embodiments discussed herein. Therefore, it is manifestly intended that the embodiments of the present disclosure be limited only by the claims and the equivalents thereof.

1. At least one non-transitory computer-readable storage medium having a plurality of instructions configured to enable a personal device of a user, in response to execution of the instructions by the personal device, to:
receive a user input to select performance of a user function in association with a video stream being rendered on a shared video device configured for use by multiple users;
render on the personal device an image frame of the video stream rendered on the shared video device at a time proximate to a time of the user input; and
facilitate performance of the user function.

2. The at least one computer-readable storage medium of claim 1, wherein the instructions are further configured to enable the personal device, in response to execution of the instructions by the personal device, to:
request from the shared video device, in response to the user input, the image frame; and
receive from the shared video device, subsequent to the request, the image frame.

3. The at least one computer-readable storage medium of claim 1, wherein the instructions are further configured to enable the personal device, in response to execution of the instructions by the personal device, to facilitate entry of an annotation to be associated with the video stream, the image frame, or an object within the image frame.

4. The at least one computer-readable storage medium of claim 3, wherein the instructions are further configured to enable the personal device, in response to execution of the instructions by the personal device, to facilitate entry of an annotation to be associated with an object within the image frame, including facilitate selection of the object.

5. (canceled)

6. The at least one computer-readable storage medium of claim 3, wherein the instructions are further configured to enable the personal device, in response to execution of the instructions by the personal device, to facilitate entry of textual annotations.

7. The at least one computer-readable storage medium of claim 3, wherein the instructions are further configured to enable the personal device, in response to execution of the instructions by the personal device, to facilitate entry of a like or dislike recommendation.

8. (canceled)

9. The at least one computer-readable storage medium of claim 3, wherein the instructions are further configured to enable the personal device, in response to execution of the instructions by the personal device, to store entered annotation or submit entered annotation to the shared video device or a cloud computing server.

10. The at least one computer-readable storage medium of claim 3, wherein the instructions are further configured to enable the personal device, in response to execution of the instructions by the personal device, to retrieve previously entered annotations, and facilitate edit of retrieved annotations.

11. The at least one computer-readable storage medium of claim 3, wherein the instructions are further configured to enable the personal device, in response to execution of the instructions by the personal device, to analyze user inputs or annotations entered over a period of time, and make recommendations for video streams to be rendered on the shared video device, based at least in part on a result of the analysis.

12. The at least one computer-readable storage medium of claim 1, wherein the personal device comprises a smartphone or a tablet computer.

13. The at least one computer-readable storage medium of claim 1, wherein the shared video device comprises a television or a set-top box coupled to the television.

14. (canceled)

15. At least one non-transitory computer-readable storage medium having a plurality of instructions configured to enable a personal device of a user, in response to execution of the instructions by the personal device, to:
facilitate selection of an object within an image frame of a video stream being rendered on a shared video device configured for use by multiple users; and
facilitate entry of annotation for the object.

16. The at least one computer-readable storage medium of claim 15, wherein the instructions are further configured to enable the personal device, in response to execution of the instructions by the personal device, to facilitate recognition of a user gesture made relative to the rendered image frame to select the object.

17. The at least one computer-readable storage medium of claim 15, wherein the instructions are further configured to enable the personal device, in response to execution of the instructions by the personal device, to facilitate entry of textual annotations.

18. The at least one computer-readable storage medium of claim 15, wherein the instructions are further configured to enable the personal device, in response to execution of the instructions by the personal device, to facilitate entry of a like or dislike recommendation.

19. (canceled)

20. The at least one computer-readable storage medium of claim 15, wherein the instructions are further configured to enable the personal device, in response to execution of the instructions by the personal device, to store entered annotation or submit entered annotation to the shared video device or a cloud computing server.

21. The at least one computer-readable storage medium of claim 15, wherein the instructions are further configured to enable the personal device, in response to execution of the instructions by the personal device, to retrieve previously entered annotations, and facilitate edit of retrieved annotations.

22. The at least one computer-readable storage medium of claim 15, wherein the instructions are further configured to enable the personal device, in response to execution of the instructions by the personal device, to analyze user inputs or annotations entered over a period of time, and make recommendations for video streams to be rendered on the shared video device.

23. At least one non-transitory computer-readable storage medium having a plurality of instructions configured to enable a personal device of a user, in response to execution of the instructions by the personal device, to:
analyze user inputs or annotations entered over a period of time for a plurality of images associated with a plurality of video streams rendered on a shared video device configured for use by multiple users, and
make recommendations for video streams to be rendered on the shared video device, based at least in part on a result of the analysis.

24. The at least one computer-readable storage medium of claim 23, wherein the instructions are further configured to enable the personal device, in response to execution of the instructions by the personal device, to facilitate entry of a like or dislike recommendation.

25. The at least one computer-readable storage medium of claim 24, wherein the instructions are further configured to enable the personal device, in response to execution of the instructions by the personal device, to recognize a thumb-up or a thumb-down user gesture to respectively facilitate entry of a like or dislike recommendation.

26. A method comprising:
receiving, by a personal device of a user, a user input selecting performance of a user function in association with a video stream being rendered on a shared video device configured for use by multiple users;
rendering, by the personal device, an image frame of the video stream rendered on the shared video device at a time proximate to a time of the user input; and
facilitating, by the personal device, performing of the user function.

27. The method of claim 26, wherein facilitating comprises facilitating, by the personal device, entry of an annotation to be associated with the video stream, the image frame, or an object within the image frame.

28. (canceled)

29. (canceled)

30. The method of claim 26 further comprising analyzing, by the personal device, user inputs or annotations entered over a period of time, and making recommendations for video streams to be rendered on the shared video device, based at least in part on a result of the analysis.

31. A personal apparatus comprising:
one or more processors;
input mechanism coupled with the one or more processors, and configured to receive a user input to select performance of a user function in association with a video stream being rendered on a shared video device configured for use by multiple users, wherein the apparatus is configured for use by a user;
a video/image component coupled with the one or more processors, and configured to render an image frame of the video stream rendered on the shared video device at a time proximate to a time of the user input; and
a shared video device cooperation function operated by the one or more processors, coupled to the input mechanism and the video/image component, and configured to facilitate performance of the user function.

32. The personal apparatus of claim 31, wherein the shared video device cooperation function is further configured to facilitate entry of an annotation to be associated with the video stream, the image frame, or an object within the image frame.

33. (canceled)

34. (canceled)

35. The personal apparatus of claim 31, wherein the shared video device cooperation function is further configured to analyze user inputs or annotations entered over a period of time, and make recommendations for video streams to be rendered on the shared video device, based at least in part on a result of the analysis.
